(19) United States
(12) Patent Application Publication
(10) Pub. No.: US 2006/0234751 A1
(43) Pub. Date: Oct. 19, 2006

(54) Power loading method and apparatus for throughput enhancement in MIMO systems

(75) Inventors: Jyhchau (Henry) Horng, Saratoga, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/110,346

(22) Filed: Apr. 19, 2005

(51) Int. Cl. H04B 7/00; H04Q 7/20

(52) U.S. Cl. 455/522

(57) ABSTRACT

An apparatus and method for closed-loop signaling over multiple channels in a telecommunication system. Channel condition for each channel is obtained, and transmission power loading per channel is determined according to channel condition. The information bit streams is transmitted via the multiple channels over a plurality of transmitter antennas according to the power loading per channel.

### FIELD OF THE INVENTION

The present invention relates generally to data communication, and more particularly, to data communication in multi-channel communication system such as multiple-input multiple-output (MIMO) systems.

### BACKGROUND OF THE INVENTION

A multiple-input-multiple-output (MIMO) communication system employs multiple transmit antennas in a transmitter and multiple receive antennas in a receiver for data transmission. A MIMO channel formed by the transmit and receive antennas may be decomposed into independent channels, wherein each channel is a spatial sub-channel (or a transmission channel) of the MIMO channel and corresponds to a dimension. The MIMO system can provide improved performance (e.g., increased transmission capacity) if the additional dimensionalities created by the multiple transmit and receive antennas are utilized.

MIMO techniques are adopted in wireless standards, such as 3 GPP, for high data rate services. In a wireless MIMO system, multiple antennas are used in both transmitter and receiver, wherein each transmit antenna can transmit a different data stream into the wireless channels whereby the overall transmission rate is increased.

There are two types of MIMO systems, known as open-loop and closed-loop. In an open-loop MIMO system, the MIMO transmitter has no prior knowledge of the channel condition (i.e., channel state information). As such, space-time coding techniques are usually implemented in the transmitter to prevent fading channels. In a closed-loop system, the channel state information (CSI) can be fed back to the transmitter from the receiver, wherein some pre-processing can be performed at the transmitter in order to separate the transmitted data streams at the receiver side.

In a practical communication system, only a finite number of data rates can be supported, and the total transmission power from the transmitter is fixed to a certain number. When the MIMO system is operated in the relatively high SNR (signal-to-noise) region, the transmission rates for good channels (with large Eigenvectors λ) are usually operated in peak transmission rate and lower transmission rates are supported for those channels with smaller Eigenvalues. In applications, such as real-time video services, it is required for the system to reach the peak transmission rate in all channels for high throughput data transmission. Under this consideration, conventional methods such as the “water-filling” algorithm for power loading (power control) cannot guarantee maximal capacity in a relatively high SNR region for a practical communication system. A water-filling algorithm is described in D.-S. Shiu, G. J. Fochini, M. J. Gans, and J. M. Kahn, “Fading correlation and its effect on the capacity of multi-element antenna systems”, IEEE Trans. Communication, vol. 48, pp. 502-513, March 2000, incorporated herein by reference.

### BRIEF SUMMARY OF THE INVENTION

The present invention addresses the above shortcomings. In one embodiment, the present invention provides a closed-loop type MIMO system with throughput enhancements in high data rate transmission.

A power loading transmission method is provided for signaling over multiple channels in a telecommunication system. In on embodiment, channel condition for each channel is obtained, and a controller determines transmission power loading per channel according to channel condition. The information bit streams is transmitted via the multiple channels over a plurality of transmitter antennas according to the power loading per channel.

In another embodiment, the controller further selects channel transmission rate based on an estimate of SNR for each channel. The controller further allocates transmission power to the multiple channels based on channel eigenvalues to increase transmission rates of channels with low eigenvalues values. When SNR is higher than a threshold for peak rate transmission in channels with high eigenvalues, the controller adaptively reallocates excess transmission power to channels with small eigenvalues to increase transmission rates of the channels with small eigenvalues, thereby increasing overall system throughput. The controller further selects lower power loading for channels with high eigenvalues, and selects higher power loading for channels with low eigenvalues.

The telecommunication system further comprising a receiver that receives the transmitted data streams and demodulates the received data streams based on power loading selection of the transmitter. In one example, the transmitter provides power loading information to the receiver. In another example, the receiver estimates power loading selections of the transmitter. The controller can further select antenna transmission power loading for each channel based on channel condition.

As such, the controller essentially optimizes transmission power distribution per channel for enhanced system throughput, by providing uneven power loading among the multiple channels based on channel condition.

These and other features, aspects and advantages of the present invention will become understood with reference to the following description, appended claims and accompanying figures.

### BRIEF DESCRIPTION OF THE DRAWINGS

FIG. 1 shows a block diagram of a conventional SVD-type MIMO beanforming system.

FIG. 2 shows a flowchart of example steps of uneven power loading in a MIMO system according to an embodiment of the present invention.

FIG. 3 shows a functional block diagram of a MIMO system implementing uneven power loading according to an embodiment of the present invention.

FIG. 4 shows a function block diagram of a power loading calculator according to an embodiment of the present invention.

### DETAILED DESCRIPTION OF THE INVENTION

In a MIMO system, transmission power has to be properly distributed over the antennas to maximize the capacity. For an unknown channel, uniform power distribution over the antennas can be applied. For a known channel, optimum power distribution using the “water-filling” technique can be utilized, wherein the “water-filling” algorithm can be derived after converting the MIMO channel into a set of parallel channels using a singular value decomposition (SVD) of the channel matrix.

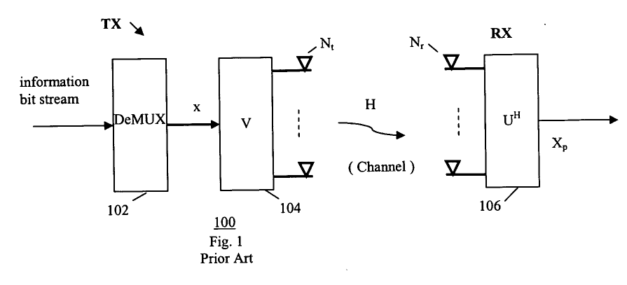

Referring to the example function block diagram in FIG. 1, a conventional SVD-type MIMO system 100 includes a transmitter TX and a receiver RX, providing a beamforming technique used in closed-loop MIMO systems. Using SVD, a MIMO channel can be decomposed into several independent channels for data transmission, and therefore, there are no interferences between different data streams at the receiver.

For the MIMO system 100 having a channel H, and Nₜ transmission antennas and Nᵣ receiving antennas, the received signal Y can be represented as:
Y=Hx+n (1)

where x is the transmitted signal and n is the additive noise. The channel H comprises a Nᵣ×Nₜ matrix, wherein an element hᵢⱼ of the matrix is the channel response from j^{th} transmit antenna to i^{th} receiving antenna.

By applying SVD to the channel H, H can be expressed as:
H=U D V^{H} (2)

where U and V are unitary matrices (i.e., U is a Nᵣ×Nₛₛ matrix where Nₛₛ is the number of data stream, and V^{H} is a Nₛₛ×Nₜ matrix), and D is a Nₛₛ×Nₛₛ diagonal matrix with the elements equal to the square-root of Eigenvalues of the matrix (HH^{H}), and the superscript ^{H} is the Hermitian operation.

In the system 100 of FIG. 1, DeMUX processing 102 splits the information bits into several streams, wherein each stream is provided to a different transmit antenna. After DeMUX processing 102, using V processing 104 the matrix V is multiplied by the data vector x (at the transmitter TX), and using U^{H} processing 106 the received data vector y is multiplied by the matrix U^{H} (at the receiver RX), whereby the so processed received signal, Xₚ, can be expressed as:
Xₚ=Dx+U^{H}n (3)

From relation (3), the transmitted data x can be completely because D is a diagonal matrix. The capacity C for the system 100 of FIG. 1 can be expressed as:

$$C = {\sum }_{i} ( 1 + \frac{{λ}_{i} {p}_{i}}{{σ}^{2}} ) \qquad ( 4 )$$

where λᵢ and pᵢ are Eigenvalues and loading powers, respectively, corresponding to the decomposed channels, and σ² is the noise power (i ranges from 1 to Nₛₛ).

In order to maximize the system capacity, conventionally higher power is assigned for those channels with larger λ, which is referred to in the afore-mentioned water filling algorithm. However, as noted, in a practical communication system, only a finite number of data rates can be supported and the total transmission power from the transmitter is fixed to a certain number.

When the conventional system 100 is operated in the relatively high SNR (signal-to-noise) region, the transmission rates for good channels (with large Eigenvectors λ) are usually operated in peak transmission rate and lower transmission rates are supported for those channels with smaller Eigenvalues. In applications such as real-time video services, it is required for the system to reach the peak transmission rate in all channels for high throughput data transmission. Under this consideration, the water-filling algorithm in system 100 for power loading cannot guarantee maximal capacity in a relatively high SNR region for a practical communication system.

In practice, a channel transmission rate is selected based on the estimated SNR for that channel. For a particular type of service, different SNR values are required to support the same transmission rate to meet the quality of service (QoS) requirement.

According to an embodiment of the present invention, for the relatively high SNR region in which SNR is higher than a threshold for peak rate transmission in good channels (channels with high Eigenvalues), the excess power is reallocated to the channels with smaller Eigenvalues, such that these channels have better chances to support higher transmission rates. In general, the goal is to let all the channels operate at the same transmission rate, i.e. the peak rate rₚₑₐₖ. Therefore, from relation (4) above:

$$\frac{{λ}_{i} {p}_{i}}{{σ}^{2}} = {r}_{peak} . \qquad ( 5 )$$

Under fixed transmit power constraint, the sum of loading powers pᵢ are set to Pₜₒₜₐₗ (wherein Pₜₒₜₐₗ is a fixed number which is equal to the total transmission power):

$${\sum }_{i} {p}_{i} = {P}_{total} \qquad ( 6 )$$

wherein the power loading (power control) pᵢ corresponding to the channel with Eigenvalue λᵢ can be expressed as:

$${p}_{i} = \frac{{P}_{total}}{{λ}_{i} {\sum }_{j} ( \frac{1}{{λ}_{j}} )} \qquad ( 7 )$$

The results in relation (7) indicate that lower power loading should be assigned for better channels with higher Eigenvalues, which is the reverse of the aforementioned conventional water-filling method (in relation (7), both i and j range from 1 to Nₛₛ). For multi-carrier systems, such as orthogonal frequency division multiplexing (OFDM) systems, the results in relation (7) can be applied on sub-carrier basis. As such, each sub-carrier (frequency tone) has its own power loading Pᵢⱼ, where i and j are the indexes for data stream and sub-carrier, respectively.

It is noted that relation (5) also guarantees all channels will operate under same SNR. It can be applied to beamforming systems supporting same transmission rates for all data streams. This is because the operation conditions or SNR for all channels should be the same in such systems. Therefore, the results in relation (7) are also applicable to such systems.

Using the channel condition, a power loading (power control) method according to an embodiment of the present invention utilizes the Eigenvalue of each transmit channel to calculate the power allocation to that transmit channel. The overall throughput performance is based on performance from each transmit channel/antenna. The power to each channel is changed in real-time based on Eigenvalue of the channel to improve overall system throughput performance.

In one implementation, the channel condition is determined based on channel estimation by either the transmitter or the receiver as is known to those skilled in the art. Based on the channel condition, the transmitter determines the transmit power for each channel and antenna according to the present invention. As such the power loading pᵢ for each transmit channel is determined, and pᵢ is applied to the transmit data x, before the matrix V.

Preferably, transmit power is distributed per channel to optimize system throughput performance. In one example, power loading for the channel with the largest (dominant) Eigenvalue is determined, and then power loading for remaining channels is determined.

When the SNR thresholds for peak rate transmission are known, the excess power for i^{th} channel can be determined as:
pᵢ^{ex}=pᵢ−pᵢ^{th} (8)

where pᵢ^{th} is the power threshold for peak rate transmission in ith channel. Because the power threshold is selected such that the peak rate can be supported with required QoS, the power loading policy becomes:
pᵢ=pᵢ^{th} for ∀i, such that pᵢ^{ex}≧0. (9)

The total excess power Pₑₓ for good channels can be obtained as:

$${P}_{ex} = {\sum }_{i ∈ \{ {p}_{i}^{ex} \geq 0 \}} {p}_{i}^{ex} . \qquad ( 10 )$$

If pᵢ is rank ordered in decreasing order, starting with the equal power, the power loading policy becomes:

$$\begin{matrix}{p}_{i} = {p}_{i}^{th} for ∀ i , such that \{ {P}_{ex} + {\sum }_{j = 1}^{i} {p}_{j}^{ex} \} \geq 0 & ( 11 a ) \\ {p}_{i} = {p}_{i} for ∀ i , such that \{ {P}_{ex} + {\sum }_{j = 1}^{i} {p}_{j}^{ex} \} < 0 & ( 11 b )\end{matrix}$$

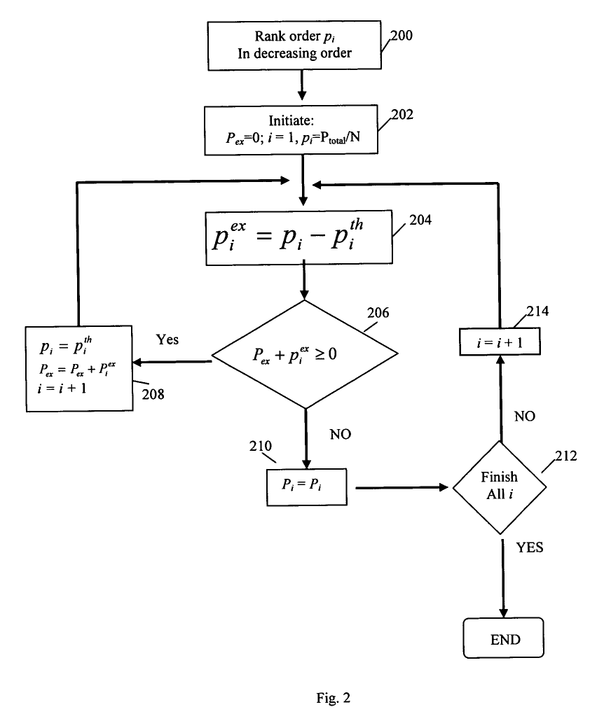

FIG. 2 shows an example flowchart of the power loading steps according to an embodiment of the present invention. The values pᵢ are rank ordered in decreasing order (step 200), and the values Pₑₓ, i and pᵢ are initialized as: Pₑₓ=0; i=1, pᵢ=Pₜₒₜₐₗ/N (step 202). Then, according to relation (8) above, pᵢ^{ex}=pᵢ−pᵢ^{th} (step 204). It is then determined if Pₑₓ+pᵢ^{ex}≧0 (step 206). If so, then the values Pₑₓ, pᵢ and i are updated as: pᵢ=pᵢ^{th}; Pₑₓ=Pₑₓ+Pᵢ^{ex} and i=i+1 (step 208) and the process returns to step 204. If in step 206, Pₑₓ+pᵢ^{ex}≧0 is not true, then pᵢ=pᵢ in step 210. It is then determined if all values i have been considered (step 212). If so, the process ends, otherwise i is incremented in step 214, and the process return to step 204.

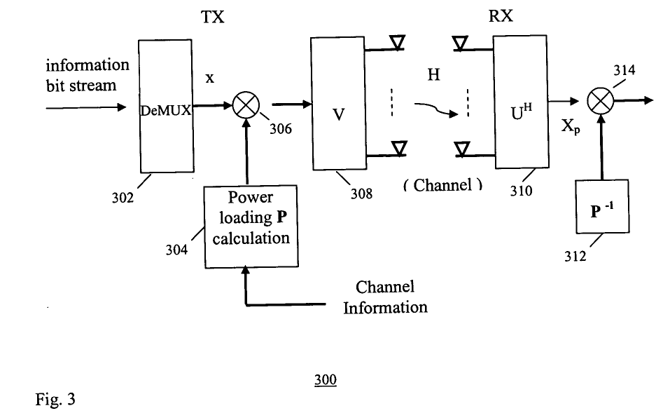

FIG. 3 shows an example block diagram of a MIMO system 300 including beamforming with uneven power loadings P per channel, according to an embodiment of the present invention. The MIMO system 300 in FIG. 3 includes a transmitter TX comprising a demultiplexer DeMUX 302, a Loading Calculator 304 that implements power control for each transmitter antenna, a Combiner 306 and a V processing function 308. The demultiplexer DeMUX 302 splits the incoming information bits into Nₛₛ streams. Each data stream is multiplied in the Combiner 306 by the respective power loading P calculated by the Loading Calculator 304. The MIMO system 300 further includes a receiver RX comprising a U^{H} processing function 310 as above, a P⁻¹ function 312 and a Combiner 314. The matrix P⁻¹ in function 312 is a Nₛₛ-by-Nₛₛ square matrix with inverse of the power loading P for each stream along the diagonal. The Combiner 314 provides a multiplication operation.

In the MIMO system 300 of FIG. 3, the receiver RX is provided with the power loading information used by the transmitter TX, via the P⁻¹ function 312. Using the power loading information the receiver RX can properly demodulate the received signals. In one example, the transmitter TX provides the power loading information to the receiver RX. In another example, the receiver RX estimates the power loading of the transmitter TX.

The Loading Calculator 304 of the MIMO system 300 implements adaptive power loading for different transmit channels according to the present invention. In one embodiment, where the SNR thresholds for peak rate transmission are known, the Loading Calculator 304 performs channel power loading according to relations (8) through (11) above.

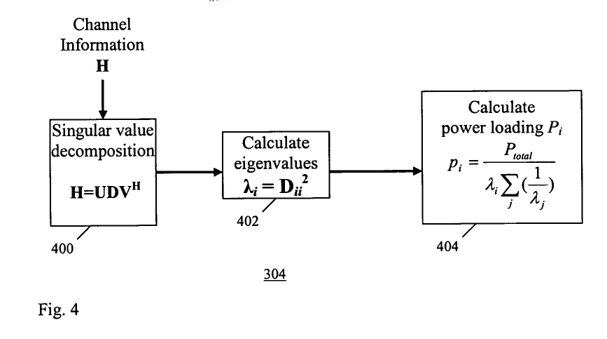

In another embodiment, the Loading Calculator 304 performs channel power loading according to relation (7) above, as shown in more detail by example in FIG. 4. In the example of FIG. 4, the Loading Calculator 304 comprises a Singular Value Decomposer 400 that performs the operation H=UDV^{H} on channel state information, an Eigenvalue Calculator 402 that performs the operation λᵢ=Dᵢᵢ² (where Dᵢᵢ is the i^{th} diagonal term in matrix D), and a Power Loading Calculator 404 that calculates power loading pᵢ as

$${p}_{i} = \frac{{P}_{total}}{{λ}_{i} {\sum }_{j} ( \frac{1}{{λ}_{j}} )} ,$$

wherein Pₜₒₜₐₗ is the total transmission power from the transmitter.

Yet another alternative Power Loading Calculator 404 according to the present invention begins with pᵢ in relation (7) above and then calculates

$${p}_{i} = \frac{P}{{λ}_{i} {\sum }_{j} ( \frac{1}{{λ}_{j}} )} ,$$

if λⱼ is known for all j. Other uneven (variable) power loading schemes according to the present invention are possible. As such, the present invention is not limited to the examples provided herein.

As noted, the conventional water filling method works in low and mid SNR ranges for capacity maximization, but not for high SNR regions. For high SNR region, the present invention provides a closed-loop signaling method for controlling power loading of multiple channels, which achieves better performance (throughput) than the water filling algorithm. Indeed, computer simulations show that e.g. ˜3 dB gain on BER (bit error rate) can be achieved for a 2×2 MIMO system with equal power loading according to the present invention. It is noted that when the same transmission rate (same constellation and same coding rate) is adopted across all data streams in some MIMO beamforming systems, the present invention can be applied to such systems for all the SNR ranges.

The present invention has been described in considerable detail with reference to certain preferred versions thereof; however, other versions are possible. Therefore, the spirit and scope of the appended claims should not be limited to the description of the preferred versions contained herein.

What is claimed is:

1. A telecommunication system, comprising:
a wireless transmitter that transmits data streams via multiple channels over a plurality of antennas, the transmitter including a power controller that selects transmission power loading per channel according to the channel condition.

2. The system of claim 1 wherein the transmitter is a MIMO transmitter.

3. The system of claim 1 wherein the controller further selects antenna transmission power loading for each channel based on channel condition.

4. The system of claim 1 further comprising means for obtaining channel conditions for use by the controller.

5. The system of claim 1 wherein the controller further essentially optimizes transmission power distribution per channel for enhanced system throughput.

6. The system of claim 1 wherein the controller provides uneven power loading among the multiple channels.

7. The system of claim 1 wherein the controller further selects channel transmission rate based on an estimate of SNR for each channel.

8. The system of claim 1 wherein the controller further allocates transmission power to the multiple channels based on channel eigenvalues to increase transmission rates of channels with low eigenvalues values.

9. The system of claim 8 wherein when SNR is higher than a threshold for peak rate transmission in channels with high eigenvalues, the controller adaptively reallocates excess transmission power to channels with small eigenvalues to increase transmission rates of the channels with small eigenvalues, thereby increasing overall system throughput.

10. The system of claim 1 wherein the controller further selects lower power loading for channels with high eigenvalues, and selects higher power loading for channels with low eigenvalues.

11. The system of claim 1 further comprising a receiver that receives the transmitted data streams and demodulates the received data streams based on power loading selection of the transmitter.

12. The system of claim 11 wherein the transmitter provides power loading information to the receiver.

13. The system of claim 11 wherein the receiver estimates power loading selections of the transmitter.

14. The system of claim 11 wherein the telecommunication system comprises a close-loop MIMO system.

15. The system claim 1 wherein the wireless transmitter operates on a multi-carrier basis, such that the power controller selects transmission power loading per channel on a sub-carrier basis.

16. The system of claim 15 wherein the wireless transmitter comprises an orthogonal frequency division multiplexing (OFDM) transmitter.

17. A closed-loop signaling method over multiple channels in a telecommunication system, comprising the steps of:
obtaining an information bit stream;
obtaining channel condition for each channel;
determining transmission power loading per channel according to channel condition; and
transmitting the information bit stream via said multiple channels over a plurality of transmitter antennas according to the power loading per channel.

18. The method of claim 17 wherein the transmitter comprises a MIMO transmitter.

19. The method of claim 17 wherein the step of determining power loading further includes the steps of selecting antenna transmission power loading for each channel based on channel condition.

20. The method of claim 17 wherein the step of obtaining channel condition further includes the steps of determining the eigenvalue for each channel.

21. The method of claim 17 wherein transmission power distribution over said multiple channels is essentially optimized for enhanced system throughput.

22. The method of claim 17 wherein the step of determining power loading further includes the steps of selecting uneven power loading among the multiple channels.

23. The method of claim 17 wherein the step of determining power loading further includes the steps of selecting channel transmission rate based on an estimate of SNR for each channel.

24. The method of claim 17 wherein the step of determining power loading further includes the steps of allocating transmission power to the multiple channels based on channel eigenvalues to increase transmission rates of channels with low eigenvalues values.

25. The method of claim 24 wherein the step of determining power loading further includes the steps of:
when SNR is higher than a threshold for peak rate transmission in channels with high eigenvalues, adaptively reallocating excess transmission power to channels with small eigenvalues to increase transmission rates of the channels with small eigenvalues, thereby increasing overall system throughput.

26. The method of claim 17 wherein the step of determining power loading further includes the steps of selecting lower power loading for channels with high eigenvalues, and selecting higher power loading for channels with low eigenvalues.

27. The method of claim 17 further comprising the steps of:
receiving the transmitted bits streams in a receiver; and
demodulating the received bit streams based on power loading selection of the transmitter.

28. The method of claim 27 wherein the transmitter provides power loading information to the receiver.

29. The method of claim 27 further including the steps of the receiver estimating power loading selections of the transmitter.

30. The method of claim 17 wherein the telecommunication system operates on a multi-carrier basis, further including the steps of selecting transmission power loading per channel on a sub-carrier basis.

31. The method of claim 30 wherein telecommunication system comprises a wireless comprises an orthogonal frequency division multiplexing (OFDM) system.
